(19) United States
(12) Patent Application Publication
(10) Pub. No.: US 2026/0172990 A1
(43) Pub. Date: Jun. 18, 2026

(54) INCREASED UPLINK POWER FOR CARRIER AGGREGATION IN WIRELESS SYSTEMS

(71) Applicant: INTERDIGITAL PATENT HOLDINGS, INC., Wilmington, DE (US)

(72) Inventors: Virgil Comsa, Montreal (CA); Paul Marinier, Brossard (CA)

(73) Assignee: INTERDIGITAL PATENT HOLDINGS, INC., Wilmington, DE (US)

(21) Appl. No.: 18/706,993

(22) PCT Filed: Nov. 3, 2022
(86) PCT No.: PCT/US2022/048771

§ 371 Date: May 2, 2024

Related U.S. Application Data
(60) Provisional application No. 63/275,188, filed on Nov. 3, 2021.

(51) Int. Cl. H04W 52/36; H04W 8/22

(52) U.S. Cl. CPC H04W 52/367; H04W 8/22; H04W 52/365

(57) ABSTRACT

Devices, methods, and systems for switching between power class combinations. An indication of a plurality of aggregated power class (PC) configurations is transmitted. Each of the plurality of aggregated PC configurations indicates respective maximum power and duty cycle information. A request is transmitted responsive to a triggering event. The request indicates a first aggregated PC configuration of the plurality of aggregated PC configurations. An indication of a second aggregated PC configuration is received in response to the request. A transmission is transmitted with a transmit power or power headroom that is based on the second aggregated PC configuration.

### CROSS-REFERENCE TO RELATED APPLICATIONS

This application claims the benefit of U.S. Provisional Application No. 63/275,188, filed Nov. 3, 2021, the contents of which are incorporated herein by reference.

### BACKGROUND

Specific absorption rate (SAR) is a measure of the rate at which energy is absorbed (e.g., per unit mass by a human body when exposed to a radio frequency electromagnetic field). SAR considerations may limit the transmission power of a wireless transmit/receive unit (WTRU).

The transmission power of a WTRU can be described in terms of power class (PC), and accordingly, SAR considerations may limit the power class (PC) of a WTRU. For example, 3GPP Rel-15 to Rel-17 for NR describes a SAR limit compliance mechanism.

Carrier Aggregation (CA) is a technique where, for example, multiple component carriers may be assigned to the same user in order to increase the data rate of a transmission. CA may be implemented for spectrum aggregation in DL (downlink) and UL (uplink) transmissions. CA may be limited due to coverage issues in some scenarios where the power class (PC) of the WTRU is limited.

### SUMMARY

Devices, methods, and systems for switching between power class combinations. An indication of a plurality of aggregated power class (PC) configurations is transmitted. Each of the plurality of aggregated PC configurations indicates respective maximum power and duty cycle information. A request is transmitted responsive to a triggering event. The request indicates a first aggregated PC configuration of the plurality of aggregated PC configurations. An indication of a second aggregated PC configuration is received in response to the request. A transmission is transmitted with a transmit power or power headroom that is based on the second aggregated PC configuration.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a schematic diagram illustrating an example WTRU radio frequency (RF) carrier aggregation (CA) architecture; and

FIG. 3 shows three line graphs illustrating WTRU output aggregated power gain and uplink perceived throughput (UPT) versus SAR compliance;

FIG. 4 is a flow chart illustrating an example power class change operation; and

FIG. 5 is a flow chart illustrating an example power class change operation.

### DETAILED DESCRIPTION

Some implementations provide a wireless transmit/receive unit (WTRU). The WTRU includes circuitry configured to transmit an indication of a plurality of aggregated power class (PC) configurations, each of the plurality of aggregated PC configurations indicating respective maximum power and duty cycle information. The WTRU includes circuitry configured to transmit a request responsive to a triggering event, the request indicating a first aggregated PC configuration of the plurality of aggregated PC configurations. The WTRU includes circuitry configured to receive an indication of a second aggregated PC configuration. The WTRU includes circuitry configured to transmit a transmission with a transmit power or power headroom that is based on the second aggregated PC configuration.

In some implementations, the triggering event includes a signal below a measurement threshold for at least one frequency band, or a power headroom below a power headroom threshold for at least one frequency band. In some implementations, the indication of the second aggregated PC configuration includes an activation time and/or a validity indication. In some implementations, the WTRU is configured for inter-band UL carrier aggregation. In some implementations, the transmission includes a power headroom report (PHR). In some implementations, the WTRU includes circuitry configured to transmit the transmission with a transmit power or power headroom that is based on a third aggregated PC configuration from among the plurality of aggregated PC configurations prior to transmitting the request, wherein the triggering event occurs while using the third aggregated PC configuration. In some implementations, the WTRU includes circuitry configured to transmit based on a third aggregated PC configuration prior to transmitting the request.

Some implementations provide a method for configuring an aggregated PC of a WTRU. An indication of a plurality of aggregated PC configurations is transmitted. Each of the plurality of aggregated PC configurations indicates respective maximum power and duty cycle information. A request is transmitted, responsive to a triggering event. The request indicates a first aggregated PC configuration of the plurality of aggregated PC configurations. An indication of a second aggregated PC configuration is received. A transmission is transmitted with a transmit power or power headroom that is based on the second aggregated PC configuration. In some implementations, the triggering event includes a signal below a measurement threshold for at least one frequency band, or a power headroom below a power headroom threshold for at least one frequency band.

In some implementations, the indication of the second aggregated PC configuration includes an activation time and/or a validity indication. In some implementations, the WTRU is configured for inter-band UL carrier aggregation. In some implementations, the transmission includes a PH report. In some implementations, the a transmission is transmitted with a transmit power or power headroom that is based on a third aggregated PC configuration from among the plurality of aggregated PC configurations prior to transmitting the request, wherein the triggering event occurs while using the third aggregated PC configuration. In some implementations, a transmission is transmitted based on a third aggregated PC configuration prior to transmitting the request.

Some implementations include a wireless base station. The base station includes circuitry configured to receive, from a wireless transmit/receive unit (WTRU) an indication of a plurality of aggregated power class (PC) configurations, each of the plurality of aggregated PC configurations indicating respective maximum power and duty cycle information. The base station includes circuitry configured to receive, from the WTRU, a request responsive to a triggering event, the request indicating a first aggregated PC configuration of the plurality of aggregated PC configurations. The base station includes circuitry configured to transmit an indication of a second aggregated PC configuration to the WTRU. The base station includes circuitry configured to receive a transmission, from the WTRU, with a transmit power or power headroom that is based on the second aggregated PC configuration.

In some implementations, the triggering event includes a signal below a measurement threshold for at least one frequency band, or a power headroom below a power headroom threshold for at least one frequency band. In some implementations, the indication of the second aggregated PC configuration includes an activation time and/or a validity indication. In some implementations, the WTRU is configured for inter-band UL carrier aggregation. In some implementations, the transmission includes a PH report. In some implementations, the base station includes circuitry configured to receive a transmission with a transmit power or power headroom that is based on a third aggregated PC configuration from among the plurality of aggregated PC configurations prior to receiving the request, wherein the triggering event occurs while using the third aggregated PC configuration.

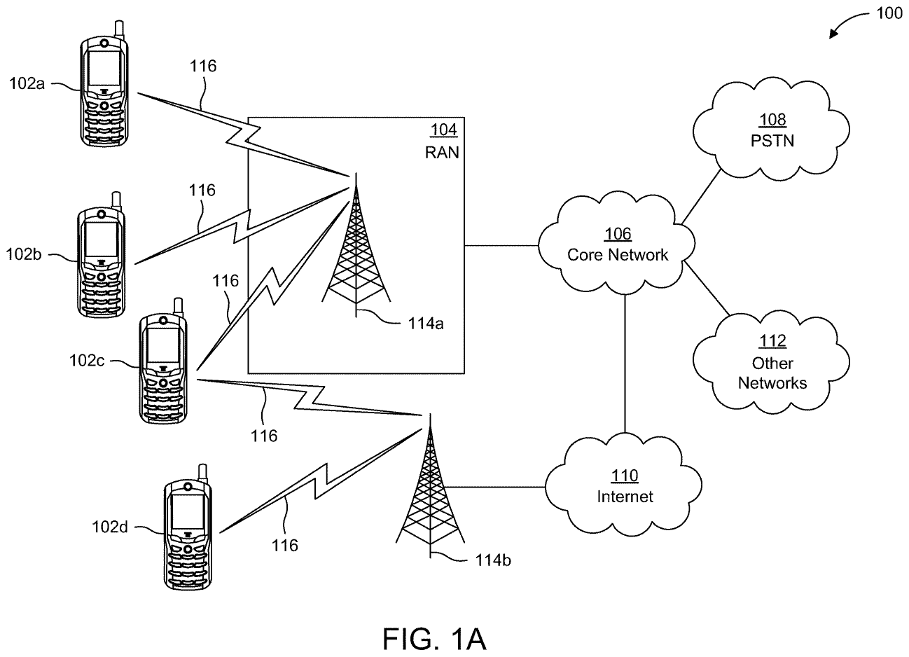

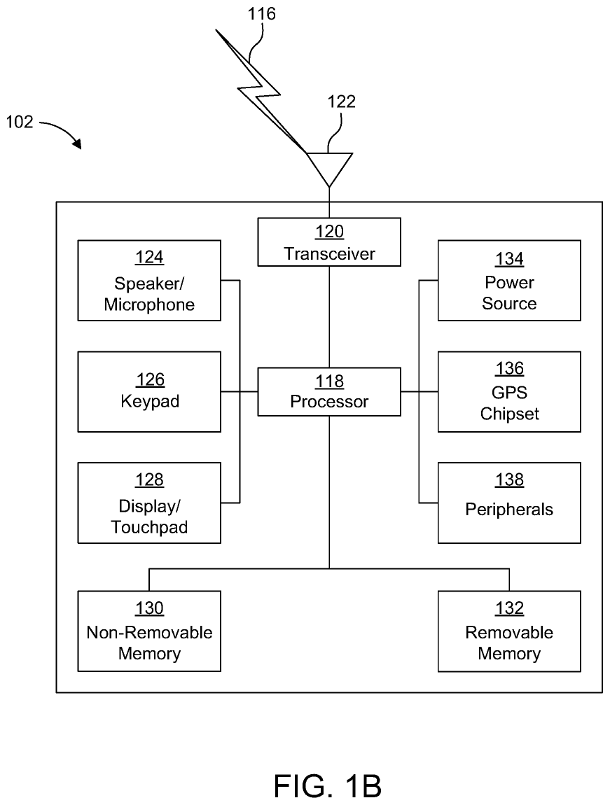

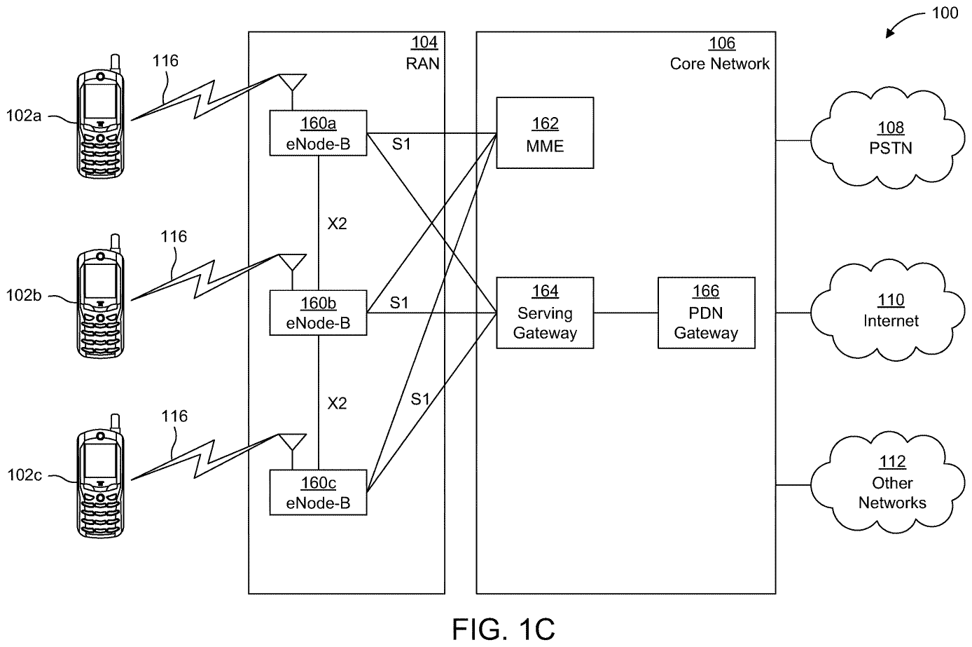

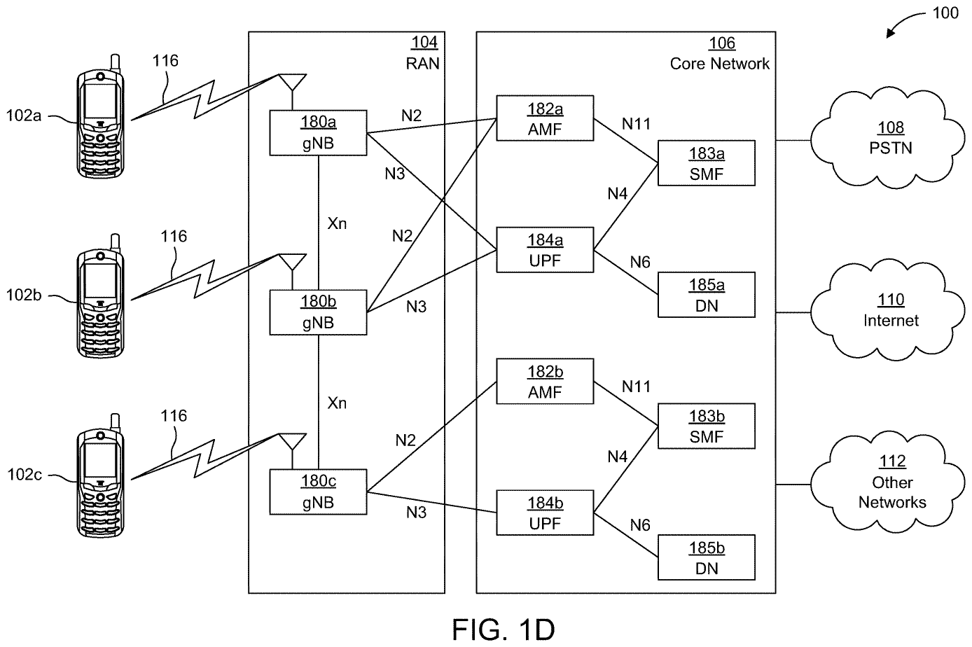

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following acronyms, among others, are used in this document:

| | |
|---|---|
| ACK | Acknowledgement |
| BLER | Block Error Rate |
| BWP | Bandwidth Part |
| CAP | Channel Access Priority |
| CAPC | Channel access priority class |
| CCA | Clear Channel Assessment |
| CCE | Control Channel Element |
| CE | Control Element |
| CG | Configured grant or cell group |
| CP | Cyclic Prefix |
| CP-OFDM | Conventional OFDM (relying on cyclic prefix) |
| CQI | Channel Quality Indicator |
| CRC | Cyclic Redundancy Check |
| CSI | Channel State Information |
| CW | Contention Window |
| CWS | Contention Window Size |
| CO | Channel Occupancy |
| DAI | Downlink Assignment Index |
| DCI | Downlink Control Information |
| DFI | Downlink feedback information |
| DG | Dynamic grant |
| DL | Downlink |
| DM-RS | Demodulation Reference Signal |
| DRB | Data Radio Bearer |
| eLAA | enhanced Licensed Assisted Access |
| eMMB | enhanced Massive Mobile Broadband |
| FeLAA | Further enhanced Licensed Assisted Access |
| HARQ | Hybrid Automatic Repeat Request |
| LAA | License Assisted Access |
| LBT | Listen-Before-Talk |
| LTE | Long Term Evolution e.g. from 3GPP LTE R8 and up |
| NACK | Negative ACK |
| MCS | Modulation and Coding Scheme |
| MIMO | Multiple Input Multiple Output |
| MOP | Maximum Output Power |
| NR | New Radio |
| OFDM | Orthogonal Frequency-Division Multiplexing |
| PA | Power Amplifier |
| PHR | Power Headroom Report |
| PHY | Physical Layer |
| PID | Process ID |
| P-MPR | Power Management Maximum Power Reduction |
| PO | Paging Occasion |
| PRACH | Physical Random Access Channel |
| PSS | Primary Synchronization Signal |
| RA | Random Access (or procedure) |
| RACH | Random Access Channel |
| RAR | Random Access Response |
| RCU | Radio access network Central Unit |
| RF | Radio Front end |
| RLF | Radio Link Failure |
| RLM | Radio Link Monitoring |
| RNTI | Radio Network Identifier |
| RO | RACH occasion |
| RRC | Radio Resource Control |
| RRM | Radio Resource Management |
| RS | Reference Signal |
| RSRP | Reference Signal Received Power |
| RSSI | Received Signal Strength Indicator |
| SAR | Specific Absorption Rate |
| SDU | Service Data Unit |
| SR | Scheduling Request |
| SRS | Sounding Reference Signal |
| SS | Synchronization Signal |
| SSS | Secondary Synchronization Signal |
| SWG | Switching Gap (in a self-contained subframe) |
| SPS | Semi-persistent scheduling |
| SUL | Supplemental Uplink |
| TB | Transport Block |
| TBS | Transport Block Size |
| TDRA | Time Domain Resource Allocation |
| TRP | Transmission/Reception Point |
| TSC | Time-sensitive communications |
| TSN | Time-sensitive networking |
| UL | Uplink |
| URLLC | Ultra-Reliable and Low Latency Communications |
| WBWP | Wide Bandwidth Part |
| WLAN | Wireless Local Area Networks and related technologies |
| | (IEEE 802.xx domain) |

In implementations where a WTRU has a defined power class in each band involved in inter-band carrier aggregation, the sum of the defined power classes per band may be referred to as aggregated power class. In some implementations, the aggregated power class also includes a related UL duty cycle per band or per WTRU (e.g., for all UL from the WTRU). In some implementations, the aggregated power class includes other information, e.g., as discussed herein. WTRU aggregated power class and related duty cycle information signaling may be of importance in the context of a SAR compliance situation, e.g., where this information is used by a BS scheduler as the basis for WTRU uplink scheduling under a CA configuration. SAR is a measure of the rate at which energy is absorbed (e.g., per unit mass by a human body when exposed to a radio frequency electromagnetic field).

Efficiently signaling changes in the WTRU power characteristics in the power and time domains may be challenging, since the base station scheduler may use this information to dynamically adapt UL grants in terms of available power and the time domain.

In some implementations, a new RRC event may be used to indicate a WTRU aggregated power class (or power limit) change. The RRC event may be triggered based on an RSRP threshold. Responsive to receiving the RRC event from the WTRU, the network (e.g., a gNB) may indicate (e.g., via PHR) a preferred aggregated power class band combination and may include an activation time. Alternatively, a PHR may be used for WTRU aggregated power class and/or power limit change. Responsive to the new RRC event or PHR, the WTRU may receive a UL transmission configuration for a specific power class combination from network.

In some implementations, responsive to reception of the PHR signaling P-MPR reduction, the network may send a WTRU aggregated power class and/or WTRU band power class activation along with the applicable/WTRU declared duty cycles in its capabilities.

In some implementations, responsive to the SAR event being triggered, the WTRU may send an explicitly suggested new WTRU aggregated power combination and related duty cycle along with the PHR.

Some implementations may include virtual PHR calculation, e.g., per WTRU virtual power headroom report, that would use the current UL grants for the slot or slots against the network suggested and/or signaled WTRU aggregated power class or defined limit.

In some implementations, a WTRU may calculate a power headroom using its averaged power over a certain period, if a duty cycle is active (i.e., if a valid power and time domain configuration is signalled by the WTRU, e.g., as a WTRU capability). The period for averaged power calculation may be configured by the network along with the PHR parameters. This power headroom may be band specific, or per WTRU.

Carrier Aggregation (CA) is a technique where the spectrum channel bandwidth of the two or more carriers is summed, either within a band (intra-band) or between two or more bands. In some implementations, CA facilitates increased spectrum capacity. CA may be used to facilitate spectrum aggregation in DL (downlink) and UL (uplink). While DL CA may be widely deployed, in some cases (e.g., in eMMB scenarios) UL CA is limited to a single carrier, e.g., due to coverage issues. In some cases, this is occurring where the typical power class (PC) per WTRU of hand-held devices is PC3 (which specifies 23 decibel-milliwatts (dBm) MOP) even if the WTRU is equipped with multiple PAs (e.g., for certain bands that use PC3 or PC2 (which specifies 26 dBm MOP). In such situations the WTRU may begin power scaling when the WTRU UL aggregated power reaches 23 dBm, for example. Thus, a UL coverage limitation may exist if UL CA is configured.

The MOP limit or PC (e.g., PC3) may be related to a SAR limit. For example, the MOP limit or PC may be based on SAR testing in specialized labs with dedicated equipment to certify a device for SAR limit compliance for a specific jurisdiction, e.g., following local administration-imposed SAR limits regulations. In some cases, SAR limits are tested against a defined UL Duty Cycle. For example, a device equipped with a PC3 PA in an FDD band may be tested using a 100% UL Duty Cycle at the maximum power without a P-MPR feature, and again with the P-MPR feature, to verify SAR limit compliance in each specific FDD band. In another example, for TDD bands, in some cases the WTRU may support a PC3 or PC2 (26 dBm MOP) PA. In such cases, in some implementations, PC2 will fall back to PC3 under certain conditions (e.g., if the UL duty cycle goes beyond 50% for a certain duration or period of time). For the PC2 case in this example, a maximum UL duty cycle may be specified, (e.g., a default maximum of 50% duty cycle) where if the UL duty cycle overshoots the maximum, the WTRU is configured to fall back to 23 dBm.

In an example, for SAR limit compliance for the PC2 case, the duty cycle may be 50%, which may lead to an averaged output power over time of, for example, 23 dBm. In some cases, SAR is an averaged measurement (e.g., a long-term averaged measurement). In such cases, peaks in aggregated output power per WTRU may be possible and/or permitted if the average aggregated power over SAR measurement period is satisfied.

In some implementations, e.g., where each CA aggregated band spectrum emission limit is respected according to the associated PA power class, the aggregated power per-WTRU may be managed solely against the SAR compliance requirements. This is valid for inter-band case. Stated another way, in implementations where for each band the WTRU respects its emission requirements at the per band defined power class level, emissions will not exceed emission requirements when the power is aggregated over more than one of these bands. In some implementations however, SAR requirements may require adjustments, e.g., in duty cycle or by applying P-MPR to one of the bands. It is noted that emissions requirements are based on pure radio emissions against a mask, whereas SAR requirements limit emissions against human tissue. P-MPR reductions are for SAR compliance, while MPR and A-MPR are coexistence in the radio environment with other users and systems.

SAR may be defined as an average level of emission over a period of time. For example, if the UL duty cycle may be 100% for at PC3 (23 dBm), the UL duty cycle can be 50% for PC2 (26 dBm) under the same SAR requirement. In some implementations, the duty cycle depends on antenna design, and may vary. In some implementations, the duty cycle is calibrated (e.g., empirically, and/or in a laboratory) before SAR compliance testing. In some implementations, SAR compliance may be managed using specific Duty Cycles under a per-WTRU power class declaration that is a composite or combination of per-band PA power classes.

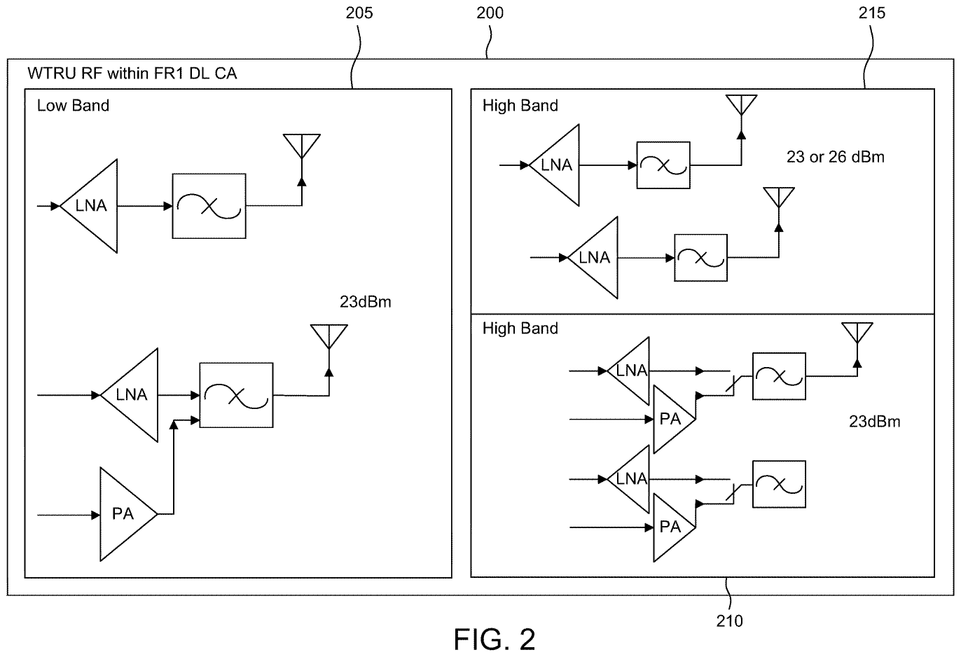

FIG. 2 is a schematic diagram which illustrates an example WTRU RF CA architecture 200. Architecture 200 includes 1 low band PA; i.e., PC3 PA 205 for FR1 low band, and 2 high band PAs; i.e., PA 210 and PA 215 for FR1 high band. In this example, PA 210 is PC3, and PA 215 may be either PC3 or PC2. These frequency, band, and MOP figures are exemplary only, and it is noted that the concepts apply to other frequencies, bands, and/or MOPs).

It is noted that when CA is configured, the WTRU aggregated power class may take different values, e.g., since there are 3 different PAs. When aggregated, the MOP per WTRU may be 26 dBm or even 28 dBm in this example. In cases where the WTRU aggregates PC3 and PC3, the result is 26 dBm (PC2). In cases where the WTRU aggregates PC3 and PC2, the result is 28 dBm). In some implementations, such power aggregation may provide increased UL coverage.

In some implementations, power aggregation may potentially lead to excess SAR, although such issues may be relevant only within a threshold distance from a human body (e.g., if the WTRU's sensors detect human body proximity.)

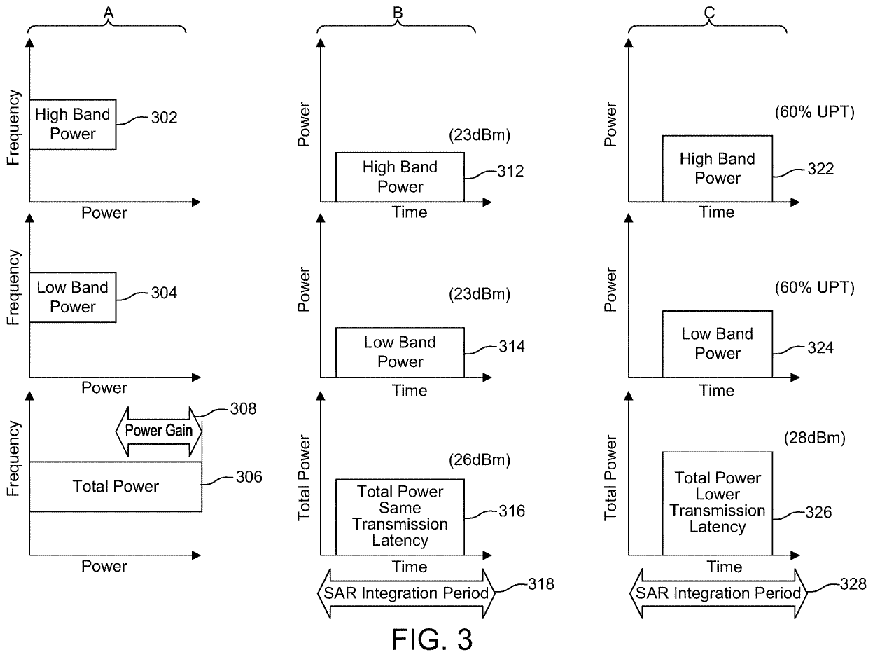

FIG. 3 is a set of line graphs illustrating example WTRU PC capabilities A, B, and C, in terms of output aggregated PC, duty cycle versus SAR compliance, and latency.

WTRU output aggregated power gain and UPT versus SAR compliance for the example TRU RF CA architecture 200 shown and described with respect to FIG. 2.

In these examples, different power aggregation levels are shown leading to different latencies and uplink perceived throughput using different duty cycles according to the UL power aggregation level against SAR integration measurement interval.

Example WTRU PC capability A provides high band power 302 over a frequency range in the case where the high band PA is PC3 and is operated at a 100% duty cycle. Example WTRU PC capability A, provides low band power 304 over a frequency range in the case where the low band PA is PC3 and is operated at a 100% duty cycle. In this case, duty cycle can go up to 100% in each frequency band channel, and the gain is in terms of coverage (UL power gain). Thus, the term “frequency range” in this context is the UL channel bandwidth in that band or an RB allocation within that channel bandwidth.

Based on high band power 302 and low band power 304, it can be seen that WTRU PC capability A provides total (or aggregated) power 306 of the low band and high band PA operation illustrated by line graphs 302 and 304, and shows the power gain 308 that results from the aggregation in this situation.

Example WTRU PC capability B provides high band power 312 over a time period in the case where the high band PA is PC2 (26 dBm) and is operated at 50% duty cycle. Example WTRU PC capability B, provides low band power 314 over a frequency range in the case where the low band PA is PC3 (23 dBm) and is operated at a 50% duty cycle.

Based on high band power 312 and low band power 314, it can be seen that WTRU PC capability B provides total (or aggregated) power 316 of the low band and high band PA operation illustrated by line graphs 312 and 314. Total aggregated power 316 is effectively PC2 (26 dBm) during SAR integration period 318.

Example WTRU PC capability C provides high band power 322 over a time period in the case where the high band PA is PC2 (26 dBm) and is operated at less than a 50% duty cycle, and UPT of 60%. Example WTRU PC capability C, provides low band power 324 over a frequency range in the case where the low band PA is PC3 (23 dBm) and is operated at less than a 50% duty cycle, and UPT of 60%. In this case, while the UPT goes down to 60% and having a duty cycle at 50% (to avoid SAR issues), the power at the highest level can be boosted to increase the coverage. In some implementations, this may be advantageous, e.g., when the latency or the data throughput is not critical.

Based on high band power 322 and low band power 324, it can be seen that WTRU PC capability C provides total (or aggregated) power 326 of the low band and high band PA operation illustrated by line graphs 322 and 324. Total aggregated power 326 is effectively 28 dBm, exceeding PC2, during SAR integration period 328. Total aggregated power 326 may be referred to as effectively PC1.5.

In some implementations, WTRU PC capability C may violate SAR limits. In this case, WTRU PC capability C may be suitable (e.g., only suitable) for situations where the WTRU is not within a threshold distance from a human body (e.g., based on WTRU sensing of human body proximity.)

While allowing for dynamic power aggregation, the MOP per WTRU (of the aggregated power class) may take different values based on the active CA band combination. Each band combination may yield a different WTRU MOP as a WTRU aggregated power class. The power class may have an associated UL duty cycle that may be defined per WTRU (e.g., across all bands that have active cells) or per-band, e.g., since the SAR limits are frequency dependent.

In a dynamic power sharing context, the WTRU aggregated power class and related duty cycle information signaling in the context of a SAR compliance situation may be used by a BS scheduler as the basis for WTRU scaling under a CA configuration.

In some cases, it may be desired to efficiently signal changes to WTRU power characteristics in the power and time domains, since the base station scheduler may use the these characteristics to adapt UL grant scheduling to dynamic changing conditions in the available power and time domain.

3GPP Rel-15 to Rel-17 for NR defines a single SAR limit compliance mechanism. Power Management Maximum Power Reduction (P-MPR) is a power management term that would reduce the maximum uplink power (P_{cmax}) e.g., responsive to sensors detecting human body proximity for a certain time duration. P-MPR action may be signaled when triggered to the network (e.g., a gNB) e.g., using MAC CE signaling, and its action is per component carrier (CC).

P-MPR is used in the equations for P_{cmax} and is significant when the reduction to P_{cmax} that it provides is higher than other spectrum emission related reductions, collectively. P-MPR is also relative to the WTRU maximum operating power (MOP) in the band where it is applied. P-MPR is reported using a PHR (Power Headroom Report) and is used by a base station scheduler to adapt the UL grants to the available power after P-MPR reduction. In some implementations, the P-MPR must be higher than MPR and A-MPR together in order to be significant and to be reported in the PHR as a P-MPR based P_{cmax} reduction.

It may be desired to signal WTRU aggregated power class and power class per-band combinations, as well as applicable UL transmission duty cycles and configurations, (e.g., where the applicable duty cycles are used in the context of SAR compliance events). Such signaling may have the advantage of enabling a higher UL CA coverage and the use of the entire WTRU UL power capabilities, e.g., while maintaining SAR compliance.

Some implementations provide WTRU aggregated power classes, combinations, capabilities, and dynamic selection. For example, in some implementations, the WTRU may signal WTRU aggregated power classes to the network (e.g., as a WTRU capability). For example, in some implementations, the WTRU may signal WTRU aggregated power classes as a WTRU capability. In some implementations, the WTRU may signal the WTRU aggregated power classes as a total power per-band combination. In some implementations, the WTRU may indicate a maximum aggregated UL duty cycle referenced against the WTRU aggregated power class. In some implementations, a duty cycle is valid when a certain power class is used; accordingly, the duty cycle is related to a certain MOP. Different MOPs may have different associated duty cycles. Alternatively, in some implementations, the WTRU may signal a per-band WTRU power class according to band combinations e.g., as a WTRU capability.

In an example, a WTRU that is equipped with three PAs on bands A, B, C (e.g., indicated as an index or a bandwidth) with MOPs X, Y, Z, (e.g., indicated as an index, as a magnitude, e.g., 23 dBM, or by power class, e.g., PC3) respectively, may report, as a WTRU capability, the following power capabilities for UL CA combinations:

$$Bands ( A + B + C ) = X + Y + Z ( dBm ) , Global Duty Cycle = N 1 \%$$

$$Bands ( A + B ) = X + Y ( dBm ) , Global Duty Cycle = N 2 \%$$

$$Bands ( A + C ) = \times + Z ( dBm ) , Global Duty Cycle = N 3 \%$$

$$Bands ( B + C ) = Y + Z ( dBm ) , Global Duty Cycle = N 4 \%$$

Here, N1, N2, N3, and N4 may be, or indicate, the duty cycle in any suitable way, such as by index or by percentage numbers in the range (1, 100), and may be related to full power PAs within their bands selected for P-MPR=0 dB (i.e., no P-MPR reduction required for the combination to be SAR compliant.) In some implementations, the N1, N2, N3, and N4 values may be determined or selected empirically; e.g., based on WTRU SAR calibration and measurements in a lab. In an example, N1%=global duty cycle (per the WTRU, as opposed to per band). The power of the PAs is aggregated for bands A and B and C using N1% ensure that no P-MPR reduction is required. (P-MPR=0 dB).

Alternatively, the WTRU may signal the power class per-band and a band-related duty cycle for a P-MPR=0 dB SAR compliant requirement e.g., as a WTRU capability. For example, using the example above for 3 bands, the following signaling scheme may be used:

$$Bands ( A ) = X ( dBm ) , Band Duty Cycle = M 1 \%$$

$$Bands ( B ) = Y ( dBm ) , Band Duty Cycle = M 1 \%$$

$$Bands ( C ) = Z ( dBm ) , Band Duty Cycle = M 1 \%$$

Here, M1, M2, and M3 may be, or indicate, the duty cycle in any suitable way, such as by index or by percentage numbers in the range (0, 100) and may be related to full power PAs within the selected band for P-MPR=0 dB (no P-MPR reduction required for the band to be standalone SAR compliant). In this context, SAR compliant means that using an Mi duty cycle in Band “i” will ensure P-MPR=0, that is, no power reduction is required. In other words, the averaged measured power density is not exceeding the SAR limit.

In some implementations, based on this band-specific signaled information, the network may compute the combination-related aggregated power class, and for full simultaneous UL transmissions, the network may scale the Mi duty cycle for each band against the P-MPR WTRU reported value or other duty cycle related information signaled dynamically by WTRU during CA operation.

Alternatively, in some implementations, the WTRU may signal a combination of the global and per-band power and duty cycle characteristics, e.g., as a WTRU capability. This may be done, for example, where some TDD bands support 26 dBm and a maximum UL duty cycle (e.g., a maximum UL duty cycle of 50% in this example), when combined with other TDD bands or FDD bands. For example, using the 3 band example above, the following WTRU capability scheme may be used:

$$Bands ( A ) = X ( dBm ) , Band Duty Cycle = M 1 \%$$

$$Bands ( B ) = Y ( dBm ) , Band Duty Cycle = M 2 \%$$

$$Bands ( C ) = Z ( dBm ) , Band Duty Cycle = M 3 \%$$

$$Bands ( A + B + C ) = X + Y + Z ( dBm ) , Global Duty Cycle = N 1 \%$$

$$Bands ( A + B ) = X + Y ( dBm ) , Global Duty Cycle = N 2 \%$$

$$Bands ( A + C ) = X + Z ( dBm ) , Global Duty Cycle = N 3 \%$$

$$Bands ( B + C ) = Y + Z ( dBm ) , Global Duty Cycle = N 4 \%$$

In some implementations, the example combinations above may cover the entire set of combinations and fallback configurations that the WTRU is capable of. In some implementations, the WTRU signals what it is capable of doing within the context of these combinations. For example, the maximum configuration capability may be for all 3 bands, and the 2 band combinations and their characteristics may be a fall back from three to two bands, and the single band configurations may be a fallback from two bands.

In some implementations, a fallback configuration may be used, e.g., when the all of the cells pertaining to a specific band are deactivated, or when they are not active for a threshold period of time, for example.

In some implementations, more than one power class may be specified for the same band. For example, two power classes X1 (with 23 dBm MOP) and X2 (with 26 dBm MOP) are defined in the example below, and may be used differently when creating a WTRU aggregated power class for a particular band combination. For this example case, the WTRU capability may take the following form, where band A has two possible values:

$$Bands ( A ) = X 1 , 1 ( dBm ) , Band Duty Cycle = M 1 , 1 \%$$

$$Bands ( A ) = X 1 , 2 ( dBm ) , Band Duty Cycle = M 1 , 2 \%$$

$$Bands ( B ) = Y ( dBm ) , Band Duty Cycle = M 2 \%$$

$$Bands ( C ) = Z ( dBm ) , Band Duty Cycle = M 3 \%$$

$$Bands ( A + B + C ) = X 1 , 1 + Y + Z ( dBm ) , Global Duty Cycle = N 1 , 1 \%$$

$$Bands ( A + B + C ) = X 1 , 2 + Y + Z ( dBm ) , Global Duty Cycle = N 1 , 2 \%$$

$$Bands ( A + B ) = X 1 , 1 + Y ( dBm ) , Global Duty Cycle = N 2 , 1 \%$$

$$Bands ( A + B ) = X 1 , 2 + Y ( dBm ) , Global Duty Cycle = N 2 , 2 \%$$

$$Bands ( A + C ) = X 1 , 1 + Z ( dBm ) , Global Duty Cycle = N 3 , 1 \%$$

$$Bands ( A + C ) = X 1 , 2 + Z ( dBm ) , Global Duty Cycle = N 3 , 2 \%$$

$$Bands ( B + C ) = Y + Z ( dBm ) , Global Duty Cycle = N 4 \%$$

In the foregoing, for example, X1,1 and X1,2 are two possible power classes for band A, and M1,1% and M1,2% are their related duty cycles.

Some implementations include global duty cycles. A global duty cycle is applied in multiple bands at the same rate. For example, for two bands, a global duty cycle of 50% will limit each aggregated band of the UL transmissions over a period of time to not exceed 50%. In some implementations, the WTRU may declare an aggregated power class that is less than the sum of the power classes per-band. For example, where a 23 dBm power class is combined with two 26 dBm power classes, and it is desired to keep the maximum WTRU aggregated power class at 28 dBm, this may be achieved by a global duty cycle that would lead to an averaged power of 28 dBm, even though 29 dBm can be achieved as a peak level in this situation. In this example, 26 dBm+26 dBm=29 dBM and if this aggregated 29 dBm PC is combined with a further 23 dBm PC, the aggregated PC exceeds 29 dBm. To keep the aggregated power class under 28 dBM for example, a global duty cycle may be applied which keeps the average power per WTRU under 28 dBm.

In such cases, in some implementations, a WTRU aggregated PC global duty cycle may be defined that is related to the maximum average power of the WTRU, and a separate duty cycle may be defined for SAR compliance per-band and/or globally. For example, depending on the antenna design and/or SAR related calibration in each band, a different duty cycle may be determined for SAR compliance. In some implementations, the duty cycle is determined globally per WTRU (i.e., for this WTRU) over all aggregated bands. In some implementations, the duty cycle is determined per band, e.g., due to frequency dependence of SAR (For example, where the human body permittivity is different at different frequencies). For this example case, without reducing the generality, the WTRU capability may take the following form:

$$Bands ( A ) = X ( dBm ) , Band Duty Cycle = M 1 \%$$

$$Bands ( B ) = Y ( dBm ) , Band Duty Cycle = M 2 \%$$

$$Bands ( C ) = Z ( dBm ) , Band Duty Cycle = M 3 \%$$

$$Bands ( A + B + C ) = Min \{ X + Y + Z , W 1 \} ( dBm ) , Global Duty Cycle = N 1 \% , S 1 \%$$

$$Bands ( A + B ) = Min \{ X + Y , W 2 \} ( dBm ) , Global Duty Cycle = N 2 \% , S 2 \%$$

$$Bands ( A + C ) = Min \{ X + Z , W 3 \} ( dBm ) , Global Duty Cycle = N 3 \% , S 3 \%$$

$$Bands ( B + C ) = Min \{ Y + Z , W 4 \} ( dBm ) , Global Duty Cycle = N 4 \% , S 4 \%$$

The foregoing describes band combinations (e.g., A, B, and/or C) with related power classes (e.g., X, Y, and/or Z) per band, global power class limits of Wi, and 2 duty cycles Ni % and Si %, where Ni % corresponds to the W global limit and Si %, is a duty cycle for SAR compliance. For example, where Wi is a power class for the specific combination, N1 is the SAR compliance related global duty cycle, and S1 is the global duty cycle for the aggregated power class that is measured as average over a certain defined period.

In some implementations, e.g., if the WTRU has to comply with the Wi aggregated power class, the WTRU may measure the output power average and may start a WTRU typical CA priority-based scaling procedure to comply with per WTRU aggregated power class within the measurement period.

Some implementations include dynamic selection of WTRU aggregated power class and/or WTRU band power class for a specific band or per band. For example, some implementations include UL CA configuration. Using the example WTRU capabilities described above, the network (e.g., a gNB) may configure the CA UL configuration indicating a specific combination of bands, power classes per-band and duty cycles. In the following description, where WTRU aggregated power class terminology is used, selection or change of WTRU aggregated power class or WTRU band related power class implies a change in the applicable global duty cycle, band related duty cycle, or both. For example, for a specific UL CA combination the WTRU may declare a duty cycle per band or a global duty cycle for the band combination that relates to a specific aggregated power class. In this case, if the combination is changed by reconfiguration by gNB, the newly selected combination will change these parameters accordingly. Accordingly, if a reconfiguration leads to a new aggregated power parameters combination, this means a change according to the new chosen capability.

In some implementations, e.g., in response to receiving a CA configuration, a WTRU may use a per-band power class indicated by the CA configuration (or in a WTRU capability information, or in another suitable way) e.g., for calculation of P_{CMAX} per CC (P_{cmax,c}) in their bands, for calculation of related PHR, and/or to perform scaling in the physical layer according to the P_{cmax,c} and the WTRU aggregated power class or P_{cmax} per WTRU. In some implementations, P_{cmax} is reported in a PHR. In some implementations, P_{cmax} is based on power class per band (e.g., is defined by equations that include power class per band). In some implementations, P_{cmax} is used in channel power allocations in the physical layer as an upper limit. In some implementations, if the P_{cmax} limit is exceeded by the required power allocation, UL power is scaled.

In some implementations, the choice of network-signaled WTRU aggregated power class and per-band power class may be related to WTRU position in the cell. In some implementations the WTRU position in the cell may be determined, e.g., by RSRP measurements reported by the WTRU.

For example, in some implementations, a WTRU that reports a strong RSRP and which is close to the cell center may not need the highest capable WTRU aggregated power class. Accordingly, the WTRU may start with a default power class, which may be a legacy or lowest aggregated power class, after receiving a UL CA configuration. In some implementations, the default UL CA power classes are known by gNB (e.g., based on standards specification). In some implementations, aggregated UL CA power classes may require a WTRU capability declaration. In some implementations, a WTRU chose a suitable UL CA configuration based on a threshold RSRP. In some implementations, a WTRU that is closer to the edge of a cell (or, e.g., further from the cell center) may need a higher WTRU aggregated power class.

In some implementations, if the WTRU supports multiple WTRU aggregated power classes, a new RRC event may be created for the WTRU aggregated power class change, and may be triggered by an RSRP threshold. In some such implementations, the network may configure the WTRU with CA and an RSRP threshold that may trigger a power class change event. In some implementations, this power class change event may be configured per-band, and may be configured for a cases where the WTRU capability includes more than one power class for a single band. For example, if two aggregated power classes are declared (e.g., PC3 with 100% duty cycle and PC2 with 50% duty cycle in one band) the band may be aggregated with another band that is declared as supporting only PC3. In some implementations, this may provide more than one (two in this example) combination for a given aggregation. In some implementations, the power class change event may be configured with a timer or other mechanism for tracking time from the event, e.g., as a “time to trigger,” which may be reset if the measurement falls under the triggering threshold for a specified duration. In some implementations, the WTRU may signal the power class change event (e.g., to a gNB) responsive to reaching the triggering conditions. In the signaling message, the WTRU may include a new suggested power class for a specific band, or for the band where the measurement event has been triggered. Alternatively, the WTRU may send an index to an entry from its declared aggregated power capabilities or any other suitable indication of a suggested power class.

Responsive to reception of the signaled event, in some implementations, the network (e.g., gNB) may send an acknowledgement (e.g., in a message) to the WTRU. In this message, the network (e.g., gNB may indicate a preferred aggregated power class band combination (e.g., from the list supplied in the WTRU capabilities information). In some implementations, this indication is an order to the WTRU to use this aggregated power class combination. In some implementations the acknowledgement and in some implementations may include an activation time for the aggregated power class combination. In some implementations the activation time may be indicated in any suitable manner, such as a frame number, a slot number, or an indication that may be interpreted as “next UL grant”. In some implementations, the network may reconfigure the power class change event according to the WTRU power capabilities.

Responsive to reception of the message from the network that specifies the new aggregated power class, in some implementations, the WTRU may apply the new received configuration, e.g., according to the indicated activation timing, or at the next UL grant.

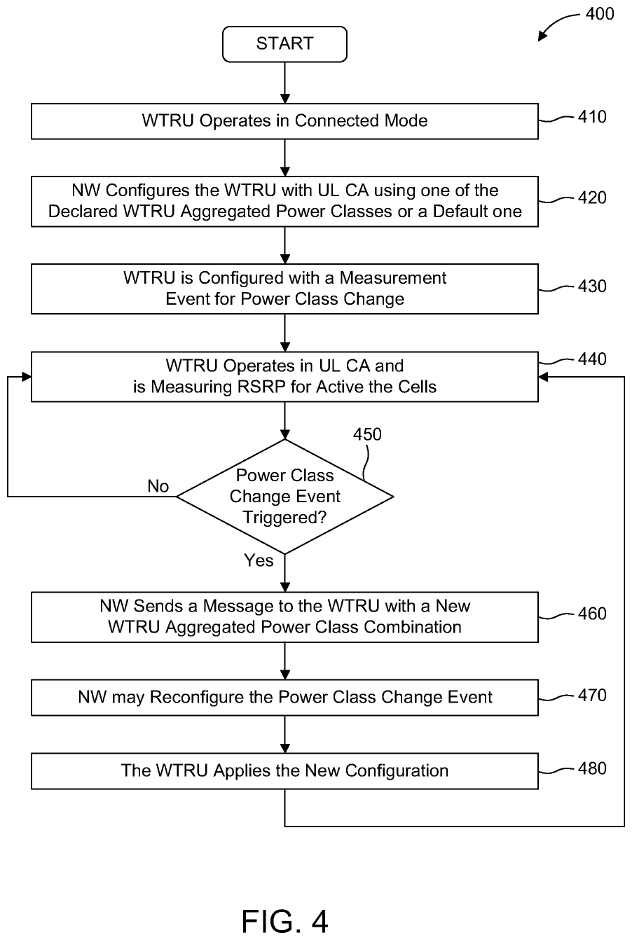

FIG. 4 is a flow chart illustrating an example power class change operation. It is noted that any step or portion of a step may be omitted or rearranged. In step 410, the WTRU enters connected mode. In step 420, the network (e.g., gNB) configures the WTRU with UL CA, e.g., using one of the declared WTRU aggregated power classes (i.e., one of the WTRU aggregated power classes in the WTRU capability list), or a default WTRU aggregated power class. In step 430, the WTRU is configured with a measurement event for a power class change. In step 440, the WTRU operates in a UL CA mode, and measures RSRP based on the measurement event. On condition 450 that the power class change event is not triggered, the WTRU continues measuring RSRP at step 440.

On condition 450 that the power class change event is triggered, the WTRU sends a message to the network indicating the power class change event, and the network sends a message to the WTRU indicating a new WTRU aggregated power class combination in step 460, the network reconfigures the power class change event in step 470, and the WTRU applies the new configuration in step 480. The flow then returns to step 440 where the WTRU operates in UL CA and measures RSRP.

Alternatively, in some implementations, the network may change the WTRU aggregated power class dynamically, e.g., responsive to reception of a PHR signaling 0 dB power or negative headroom. In some such implementations, responsive to reception of a PHR indicating 0 dB or negative headroom, the network may signal a WTRU aggregated power class change.

The power class change may be signaled by the network in any suitable manner, such as a physical layer flag or indication that may go along a DCI UL grant, a MAC CE based command for a WTRU aggregated power class, and/or RRC signaling as new aggregated power class combinations.

Responsive to reception of a WTRU aggregated power class change order (e.g., a message from the gNB either in RRC or PDCCH), in some implementations, the WTRU may send an acknowledgement (ACK) to the network and may implement the changes, e.g., starting with the following valid UL grant or at the next repetition grant (if the order is received in the middle of a repetition bundle). Alternatively, in some implementations, the activation time of a new aggregated power class combinations may be signaled as a frame number, a slot number.

In some implementations, the aggregated power class change may be triggered by the WTRU; e.g., as a PHR, e.g., where a threshold may be a headroom level that may be configured by the network. Such PHR may be referred to as an enhanced PHR. In some implementations, in the enhanced PHR, the WTRU may include a pointer to a desired WTRU aggregated power class combination from its declared capabilities, or it may explicitly indicate a band specific power class change. In some implementations, the triggered enhanced PHR may indicate the current headroom for the active power classes, per-band or global, and/or the virtual headroom for the signalled new combination desired by the WTRU.

Some implementations include uplink transmission configuration for a power class combination. In some implementations, a WTRU may receive, e.g., for each power class combination or aggregated power class, an associated transmission configuration. In some implementations, a transmission configuration associated with a power class combination may be configured per serving cell, UL carrier and/or UL bandwidth and in some implementations may include one or more of the following parameters: a time pattern or mask indicating when UL transmission is allowed; a time pattern or mask indicating when DL transmission is allowed; a TDD UL/DL slot configuration; a set of uplink resources; power control configurations related to at least one of the uplink resources; and/or a set of downlink resources. In some implementations where the transmission configuration associated with the power class combination includes a set of uplink resources, such uplink resources may include or indicate one or more of the following: a configured grant configuration, a PUSCH configuration including TDRA tables, a CSI reporting configuration, SRS resources, PUCCH resources for SR, CSI or HARQ-ACK, and/or PRACH resources. In some implementations where the transmission configuration associated with the power class combination includes a set of downlink resources, such downlink resources may include or indicate one or more of the following: CSI-RS for CSI reporting, beam failure detection or recovery, radio link monitoring and measurements, PRS, PDCCH and/or associated Coreset, and/or PDSCH (e.g. for semi-persistent scheduling).

Responsive to switching the power class combination (or aggregated power class), the WTRU may apply the transmission configuration associated with the new (i.e., switched-to) power class. For example, if the transmission configuration indicates when UL transmission is allowed (e.g., includes a time pattern which indicates when UL transmission is allowed), the WTRU may consider only uplink resources overlapping with the time pattern as available for transmission. In some implementations, the WTRU may also apply a power control configuration included in the transmission configuration associated with the new power class and other parameters such as TDRA table.

Some implementations include UL CA-CC activation and/or deactivation. In some implementations, if CC activation and/or deactivation is signaled by network, the WTRU may fall back to a new WTRU aggregated power class or WTRU band power class in some cases.

For example, in some implementations, if the WTRU has a two band UL CA configuration and a CC in one band is deactivated, the WTRU may fall back (e.g., automatically) to the remaining active band valid power class with its related duty cycle if declared.

Alternatively, the network may signal, along with CC activation and/or deactivation, the WTRU aggregated power class and/or the band or bands related to WTRU power class usage. Responsive to reception of this signal, the WTRU may apply the WTRU aggregated power class and/or the band or bands related to WTRU power class usage after sending an acknowledgement to the network (e.g., to a gNB).

In some implementations, if the CC activation/deactivation triggers a PHR, the new WTRU aggregated power class, and WTRU per-band power class assumptions may be used for the calculation of the PHRs per CCs.

Some implementations include automatic fall back to default power class, and other special cases, for UL CA. For example, in some implementations, if some or all of the CA configured CCs have P_{cmax} limitations, e.g., due to coexistence issues or other regulatory limitations (e.g., hospitals in certain countries or other restricted areas where the reduction is per WTRU), the WTRU may fall back to normal operation on a default band power class and WTRU band related power based on the cell indicated power limitations. In some implementations, this may occur in response to a handover to a target cell configuration that has a power limitation per WTRU, where the source was operating under a UL CA with an enhanced WTRU aggregated power class.

In some implementations, if the P_{cmax,c,h} limit on a certain cell is leading to a power reduction, the WTRU may continue to operate the other UL unaffected bands to their bands related power classes and duty cycles as per active WTRU aggregated power class in operation, unless the network signals a change. Here, P_{cmax,c,h} indicates an upper limit to P_{cmax,c}.

In some implementations, the WTRU may dynamically use the remaining headroom from the restricted band power for the other bands/cells.

Some implementations include selection of WTRU aggregated power class and SAR compliant duty cycles. For example, some implementations include activation of duty cycles for SAR. In some implementations, the network may select WTRU aggregated power class based on UL CA efficiency when more power is available. For example, in some such cases, the WTRU may use higher modulation orders and shorter transmission periods (lower latency) if it is not under SAR constraints (i.e., where no proximity of a human body is detected.)

In some implementations, responsive to a SAR event (i.e., in a situation where proximity of the WTRU to a human body is detected), the WTRU may signal a P-MPR action by including a flag (e.g., in the PHR) and the value of the P_{cmax} for the CC or CCs that are affected in a PHR. For example, in a case where the WTRU is operating under normal UL CA parameters, (i.e., meaning that there are no operating SAR related duty cycles), in some implementations, the WTRU may send a PHR indicating a real applied P-MPR per CC, responsive to a SAR related trigger event. Responsive to reception of the PHR signaling P-MPR, in some implementations, the network may send a WTRU aggregated power class and/or WTRU band power class activation, and may also include applicable and/or WTRU-declared duty cycles in its capabilities to the WTRU (e.g., in a reconfiguration or a MAC CE activation).

In some implementations, the activation command for the new power and/or time configuration may be a MAC CE activation order, which may include a pointer to an indication of the duty cycles configuration, or an explicit duty cycle value. Responsive to reception of the WTRU aggregated power class and duty cycles activation, in some implementations, the WTRU will acknowledge the activation command (e.g., acknowledge the MAC CE order), and may begin applying the new power class aggregation parameters at the first UL grant received after the acknowledgement. Alternatively, in some implementations, the network (e.g., a gNB) may indicate (e.g., in the activation command, e.g., MAC CE activation order) the activation time as a frame number, or slot number offset calculated from the reception of the activation order slot.

Alternatively, in some implementations, the network (e.g., a gNB) may send a physical layer order (e.g., DCI in a PDCCH order) for WTRU aggregated power class and duty cycles activation. In some implementations, the physical layer order may be sent as or by a DCI command that may carry a bit combination pointing to a WTRU aggregated power class and related duty cycles. After acknowledging the order, the WTRU may start applying the new power class aggregation parameters at the first UL grant received after the acknowledgement. Alternatively, there may be an activation time as specification defined as a slot offset, or an explicit activation time as frame number or slot offset.

Responsive to activation or the new power and duty cycle configuration, in some implementations, the WTRU may be configured with, or may switch the PHR triggers to, a different set of conditions, time periods, and/or timers that may better reflect the new power configuration versus SAR conditions control. In some implementations, this PHR parameters configuration may be linked to a list of available power configurations from the WTRU declared aggregated power capabilities list.

In some implementations, responsive to the SAR event being triggered, the WTRU may send (e.g., in the PHR) an indication of an explicitly suggested new WTRU aggregated power combination, and possibly an indication of a related duty cycle. In some implementations, the duty cycle may be a WTRU global, per WTRU, duty cycle (i.e., a duty cycle that applies to the aggregated power per WTRU declared in the WTRU capabilities) or a per active band power and preferred duty cycle (i.e., a duty cycle per-band applied to cells that have UL transmissions in a certain band). Alternatively, in some implementations, the WTRU may signal the new suggested power and/or duty cycle combinations using an indication and/or pointer to the WTRU aggregated power capabilities list.

Responsive to reception of the enhanced PHR, in some implementations, the network may acknowledge the PHR/MAC CE or may indicate a different power and/or duty cycle configuration, and may indicate an activation time that may be implicit (e.g., as a specification-based number of slots or frames) or explicit (e.g., as a frame number or slot). In some implementations, the WTRU may apply the new configuration at the appropriate time (i.e., the network-indicated activation time) and may begin using the new power assumption for the UL CA operation. Alternatively, in some implementations, the activation time may be the next available UL grant (e.g., implicitly).

Some implementations include power control for dynamic WTRU aggregated power changes. For example, some implementations include physical layer scaling rules. For example, in some implementations, the WTRU typically evaluates P_{cmax} in each and every UL transmission slot. In some implementations, the P_{cmax,c} per carrier is evaluated against the WTRU power class. In some implementations, consequently, the P_{cmax} CA for the CA case is evaluated and the WTRU complies with a corresponding higher and a lower power limit. In some implementations, the WTRU performs scaling operations in physical layer and for the calculation of the power headroom per carrier based on these per CC and CA related limits.

In some implementations, e.g., for coexistence reasons, the MOP per-band may remain the same, since all the parameters such as MPR, A-MPR are defined against the MOP/band. This may be referred to as a WTRU band power class. Under these conditions, in some implementations, P_{cmax,c} per carrier may not change. In some implementations, 26 dBm (PC2) and 23 dBm (PC3) are as specified in standards specifications.

In some implementations, the global WTRU power class operation is modified. This may be referred to as WTRU aggregated power class. The impact may be apparent at the high limit of P_{cmax} (i.e. P_{cmax,H}) where the sum or a weighted sum of the per-band MOPs may be the limit within a certain tolerance.

In some implementations, if the WTRU is operating under a new WTRU aggregated power class or a newly defined WTRU aggregated power limit, the UL CA P_{cmax, H} may change accordingly, and all of the current UL CA scaling rules may be applied against this new P_{cmax} per WTRU where P_{cmax,c,h} indicates an upper limit to P_{cmax,c}.

Some implementations include PHR report calculations. For example, when operating under UL CA with a higher maximum WTRU aggregated power, The WTRU may use the current PHR,c calculation rules per CC, e.g., since the P_{cmax,c} definition is not expected to change.

Some implementations include an actual power headroom calculation. Due to the new UL CA WTRU aggregated power and related SAR duty cycles actions, in some implementations, the WTRU may compute a per WTRU power headroom report that will consider all the active UL transmissions in the slot or overlapping slots against the WTRU aggregated power class or specification defined limit. In such cases, we may refer to the report as a per WTRU actual power headroom report.

Some implementations include a virtual power headroom calculation. Since the WTRU and/or network (e.g., gNB) may dynamically signal a new per WTRU aggregated power combination, in some implementations, the WTRU may calculate a per WTRU virtual power headroom report which may use the current UL grants for the slot or slots using the suggested WTRU aggregated power class or defined limit.

Some implementations include a new power headroom calculation with averaged power. In some implementations, the WTRU may calculate a power headroom using an averaged power over a certain period given that a duty cycle may be active. The period for averaged power calculation may be configured by the network along with the PHR parameters. This power headroom may be band specific, or per WTRU.

In some implementations a SAR indicator and/or flag may be added to the PHR, e.g., when the SAR event is triggered. In some implementations, the P-MPR value, a suggested WTRU aggregated power class and/or limit combination, and/or a duty cycle or cycles are added to the PHR. Alternatively, in some implementations, a virtual power headroom per WTRU using a suggested duty cycle is indicated in the report when an SAR event is triggered.

The following example illustrates dynamic switching between power class combinations.

First, the WTRU may determine at least one possible “power class combination.” The power class combination may include, for example, a set of applicable frequency bands and/or carriers; a maximum transmission power; and/or a maximum duty cycle and applicable period. For example, a WTRU may report a first power class combination of 23 dBm with 100% duty cycle and second power class combination of 26 dBm with 50% duty cycle, for a given band.

Next, the WTRU may report at least one possible power class combination. In some implementations, the power class combination is reported as a WTRU capability.

Next, the WTRU may receive (e.g., responsive to the report), a configuration for at least one uplink transmission configuration. The configuration may include, for example: an associated power class combination; a time pattern or mask indicating when an UL transmission is allowed; a set of uplink resources (e.g., including configured grant configurations, CSI reporting configurations, TDRA tables, SRS resources, SR resources, etc.); and/or the at least one uplink transmission configuration may be configured by serving cell, UL carrier and/or UL bandwidth part.

Next, the WTRU determines an initial power class combination (e.g., a default as indicated by configuration). For example, the WTRU may determine an initial power class combination as 23 dBm with a 100% duty cycle.

Next, the WTRU triggers and transmits a PHR. For example, the trigger may be based on an existing or new PHR trigger (e.g., where PHR is lower than a threshold).

Next, the WTRU receives an indication of a change of power class combination. In some implementations, the indication may be received as a MAC CE. For example, the indication may indicate a new power class combination as 26 dBm with 50% duty cycle.

Next, the WTRU may switch to the uplink transmission configuration associated with the indicated, changed power class combination. For example, the WTRU may apply a configured time mask to all UL transmissions of a serving cell, based on a bitmap in terms of symbols. The configured time mask may be applied, e.g., for at least one serving cell.

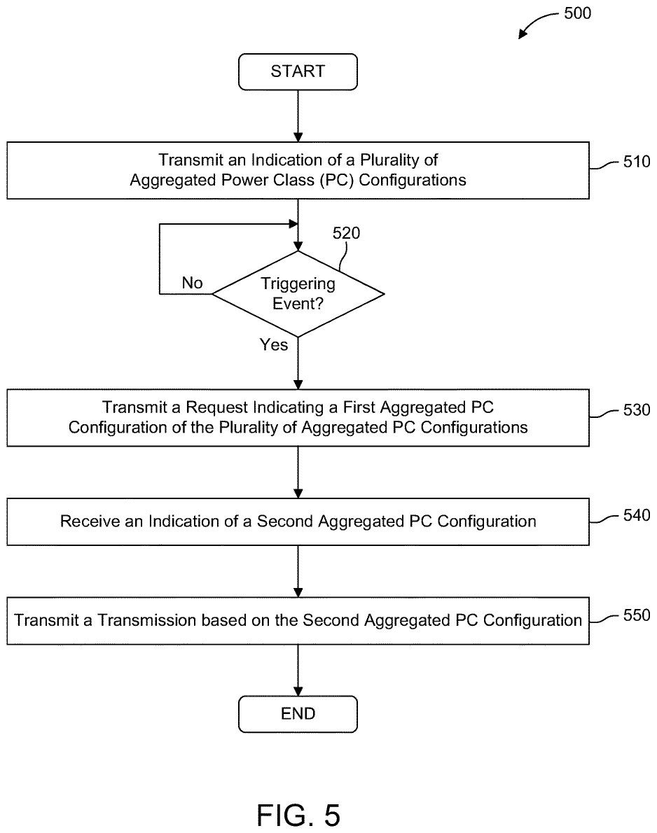

FIG. 5 is a flow chart illustrating an example power class change operation. All of the various operations described with respect to FIG. 5 may include operations as discussed earlier, e.g., with respect to SAR event triggering. In this example, the WTRU transmits an indication of a plurality of aggregated PC configurations to the network (e.g., to a gNB). On condition 520 that a triggering event occurs (e.g., a SAR trigger), the WTRU transmits a request indicating a first aggregated PC configuration of the plurality of aggregated PC configurations to the network in step 530. In response to the request, the WTRU may receives an indication of the first aggregated PC configuration (e.g., as a confirmation) or may receive an indication of a different aggregated PC configuration. In this example, the WTRU receives an indication of a second aggregated PC configuration in response to the request, in step 540, which the WTRU acknowledges in some implementations. The WTRU transmits a transmission based on the aggregated PC configuration that was indicated (the second aggregated PC configuration in this example) in step 550.

In some implementations, the request indicating a first aggregated PC configuration of the plurality of aggregated PC configurations is a suggestion to the network. In some implementations, the network choses an aggregated PC configuration for the WTRU. In some implementations, the network choses the aggregated PC configuration for the WTRU based on this suggestion. In some implementations, the network choses the aggregated PC configuration for the WTRU from among the plurality of aggregated PC configurations that were transmitted by the WTRU.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-20. (canceled)

21. A method implemented in a wireless transmit/receive unit (WTRU), the method comprising:
transmitting information indicating at least one power class capability of the WTRU, each of the at least one power class capability indicating a maximum power and a duty cycle associated with the maximum power for a band or band combination; and
transmitting, responsive to a triggering event that triggers a change in the maximum power associated with a first power class capability of the at least one power class capability, a power headroom report (PHR) which indicates the change in the maximum power associated with the first power class capability;
wherein the indication of the change in the maximum power associated with the first power class capability indicates a maximum power change for a band combination; and
wherein the triggering event comprises exceeding the duty cycle associated with the maximum power for the first power class capability.

22. The method of claim 21, wherein the change in the maximum power associated with the first power class capability is 3 db.

23. The method of claim 21, wherein the PHR indicates a serving cell maximum power (P_{cmax,c}).

24. The method of claim 23, wherein the indicated P_{cmax,c} is based on power class per band.

25. The method of claim 23, wherein the indicated P_{cmax,c} is based on the change in the maximum power associated with the first power class capability.

26. The method of claim 21, wherein the PHR indicates a power headroom value.

27. The method of claim 26, wherein the power headroom value is based on the change in the maximum power associated with the first power class capability.

28. The method of claim 21, wherein the indication of the change in the maximum power associated with the first power class capability indicates an aggregated power class.

29. The method of claim 21, wherein the indication of the change in the maximum power associated with the first power class capability indicates a power limit.

30. The method of claim 21, wherein the PHR indicates a duty cycle.

31. A wireless transmit/receive unit (WTRU) comprising:
circuitry configured to transmit information indicating at least one power class capability of the WTRU, each of the at least one power class capability indicating a maximum power and a duty cycle associated with the maximum power for a band or band combination; and
circuitry configured to transmit, responsive to a triggering event that triggers a change in the maximum power associated with a first power class capability of the at least one power class capability, a power headroom report (PHR) which indicates the change in the maximum power associated with the first power class capability;
wherein the indication of the change in the maximum power associated with the first power class capability indicates a maximum power change for a band combination; and
wherein the triggering event comprises exceeding the duty cycle associated with the maximum power for the first power class capability.

32. The WTRU of claim 31, wherein the change in the maximum power associated with the first power class capability is 3 db.

33. The WTRU of claim 31, wherein the PHR indicates a serving cell maximum power (P_{cmax,c}).

34. The WTRU of claim 33, wherein the indicated P_{cmax,c} is based on power class per band.

35. The WTRU of claim 33, wherein the indicated P_{cmax,c} is based on the change in the maximum power associated with the first power class capability.

36. The WTRU of claim 31, wherein the PHR indicates a power headroom value.

37. The WTRU of claim 36, wherein the power headroom value is based on the change in the maximum power associated with the first power class capability.

38. The WTRU of claim 31, wherein the indication of the change in the maximum power associated with the first power class capability indicates an aggregated power class.

39. The WTRU of claim 31, wherein the indication of the change in the maximum power associated with the first power class capability indicates a power limit.

40. The WTRU of claim 31, wherein the PHR indicates a duty cycle.
